(19) United States
(12) Patent Application Publication
(10) Pub. No.: US 2007/0277682 A1
(43) Pub. Date: Dec. 6, 2007

(54) Multi-function juicer

(76) Inventor: Yan Kwong Wong, Hong Kong (HK)

Correspondence Address: Michael D. Yablonsky, Ph.D., Esq.;Law Office of Sergei Orel, 660 Anderson Ave, Cliffside Park, NJ, 07010, US

(21) Appl. No.: 11/447,494

(22) Filed: Jun. 6, 2006

(51) Int. Cl. A23N 1/00

(52) U.S. Cl. 99/495

(57) ABSTRACT

The multi-function juicer is a tool used for meat grinding and juice extraction. By changing the blade and screw bolt inside, it can serve the double purpose of either meat grinding or juice extraction. By repetitively rotating the handle, the screw bolt and the blade will rotate, too. This will drive the meat to pass through the pedal blade to smash into smaller ground meat, or drive the fruit to pass through the rotating blade and screw bolt to extract juice. The wetness of the pulp can be adjusted by controlling the wetness control unit. There is no need for extra processes to separate the juice from pulp, or to control the wetness of the pulp. It provides a convenient way to use one simple juicer to extract juice from different fruits. The other special point of this invention is that it has a vacuum disk on the bottom. Before meat grinding or juice extraction, the user only needs to rotate the handle inside the body. Then this multi-function juicer will be mounted to the kitchen table, which is very convenient.

### TECHNICAL FIELD

The present invention is a multi-function juicer. To be specific, it is a multi-function juicer with a vacuum base to mount the juicer, with manual meat grinding and juice extraction devices.

### BACKGROUND TECHNOLOGY

Juicers are used to extract juice from vegetables/fruits. Current juicers can be categorized into two types: manual and electric. Both of them use two methods to extract juice. One of them is to place the fruit on the juicer and press it manually. The juice that is pressed out will flow out. A filtering device is then used to separate pulp from the juice. The problem with this approach is that it only works with fruits that can be pressed to break juice out. The other approach is to smash the peeled fruit with blades to get juice. The problem with this approach is that it requires extra steps to separate juice and pulp in the final stage. It adds extra work to the process and does not provide a single juicer to extract juice from different fruits.

### SUMMARY OF THE INVENTION

Based on the above-mentioned issues, this invention provides a multi-function juicer with a vacuum base to mount the juicer body. It can easily manually grind meat or extract fruit juice. When extracting juice, it can also control the wetness of the pulp by adjusting a wetness control unit. It does not require extra steps to separate juice and pulp.

In order to realize these goals, this invention provides a multi-function juicer, which includes the following components:

A vacuum mounting base unit on the bottom of the multi-function juicer. This vacuum base includes:

A vacuum disk that is on the bottom of the mounting vacuum base unit;

A base that covers the abovementioned vacuum disk;

A vacuum disk shelf on top of the vacuum disk;

A vacuum disk controller inside the base;

A controller fixing unit that is on the side of the base to lock the vacuum base controller;

A controller cover that is used to cover one side of the base;

A vacuum disk control handler on the other side of the base to control the operation of the vacuum disk;

A vacuum disk shelf connector that is next to vacuum disk shelf stand;

A controller locking unit that is right next to the inner side of the abovementioned vacuum control handler; and

A controller sealer that is inside the base, which, together with the vacuum base control handler, will hold the controller locking unit.

A mechanical device on one side of the upper part of multi-function juicer. This mechanical device includes:

A gearbox at the center of the mechanical device;

A rotating handler that is placed outside the gearbox; and

A big gear and a small gear inside the gearbox.

A juicer body that is placed on top of the vacuum mounting base. This body includes:

A body part that is on the top of the base.

A juice extraction device that is connected to the juicer body. This juice extraction device includes:

A juice extraction device body that is at the center of the juice extraction device;

A main screw bolt inside the device body;

A main screw bolt skirt that is placed at the end of the main screw bolt;

A small axle of the main screw bolt that is inside the main screw bolt;

A main screen board that is at the outlet of the device body;

A body nut that is attached to the abovementioned outlet of the device body;

Two sealing rings that are closely attached to the body nut;

An aux screw bolt that is inside the device body;

A small bolt of the aux screw bolt that is placed inside the aux screw bolt;

An aux screw bolt tail axle that is placed in the tail of the aux screw bolt;

A juice extraction screen board that is right on the outside of the main screen board;

A juice extraction device bottom cover that is placed on the bottom of the juice extraction device body;

A bottom cover sealer that surrounds that rim of the juice extraction device bottom cover;

A filter net that is placed on the center of the juice extraction device bottom cover;

A wetness control unit that is connected to the outlet of the device body; and

A juice extraction device nut that is tightened to the outlet of the device body.

A meat grinding unit that can be exchanged with some of the components in the juice extraction device to serve meat grinding purpose. This meat grinding unit includes:

A meat grinding screw bolt that can replace the main screw bolt to grind meat;

A meat grinding screw bolt skirt that is placed at the tail of the meat grinding screw bolt;

A meat grinding screen board that can replace the main screen board to grind meat;

A meat grinding body nut that can replace the body nut to grind meat; and

A pedal blade that can replace the juice extraction screen board to grind meat.

The function of the invention can be changed by uninstalling some components in the juice extraction device and replacing them with meat grinding components. The user can conveniently grind meat or extract juice manually. Further, by rotating the vacuum disk control handler, the juicer can be mounted to the kitchen table, which is very easy. At the same time, when extracting juice, this invention can control the wetness of the pulp by adjusting the wetness control unit. There is no need to exact pulp/juice separation process. This provides a convenient way to use one juicer to extract juice from different fruits/vegetables. Thus it resolves the two abovementioned issues.

### DESCRIPTION OF THE DRAWINGS

FIG. 1 is the perspective view of the multi-function juicer invention;

FIG. 2 is the disassembled view of the multi-function juicer invention;

FIG. 3 is the perspective view of the controller locking unit that is shown in FIG. 2;

FIG. 4 is the perspective view of the vacuum disk control handler that is shown in FIG. 2;

FIG. 5 is the front view of the controller sealer that is shown in FIG. 2;

FIG. 6 is the side view of the controller sealer that is shown in FIG. 5;

FIG. 7 is the front view of the vacuum disk shelf connector that is shown in FIG. 2;

FIG. 8 is the side view of the vacuum disk shelf connector that is shown in FIG. 7;

FIG. 9 is the side view of the vacuum disk shelf that is shown in FIG. 2;

FIG. 10 is the top view of the vacuum disk shelf that is shown in FIG. 9;

FIG. 11 is the top view of the vacuum disk controller that is shown in FIG. 2;

FIG. 12 is the front view of the vacuum disk controller that is shown in FIG. 11;

FIG. 13 is the bottom view of the small gear that is shown in FIG. 2;

FIG. 14 is the bottom view of the large gear that is shown in FIG. 2;

FIG. 15 is the top view of the gearbox that is shown in FIG. 2;

FIG. 16 is the perspective view of the main screw bolt that is shown in FIG. 2;

FIG. 17 is the perspective view of the aux screw bolt that is shown in FIG. 2;

FIG. 18 is the side view of the aux screw bolt that is shown in FIG. 17;

FIG. 19 is the bottom view of the main screen board that is shown in FIG. 2;

FIG. 20 is the bottom view of the juice extraction screen board that is shown in FIG. 2;

FIG. 21 is the perspective view of the juice extraction body that is shown in FIG. 2;

FIG. 22 is the side view of the wetness control unit that is shown in FIG. 2;

FIG. 23 is the combined front view of the juice extraction body that is shown in FIG. 21 and the wetness control unit that is shown in FIG. 22 after they are installed together and placed in status 1;

FIG. 24 is the combined front view of the juice extraction body that is shown in FIG. 21 and the wetness control unit that is shown in FIG. 22 after they are installed together and placed in status 2;

FIG. 25 is the perspective view of the juice extraction device bottom cover that is shown in FIG. 2;

FIG. 26 is the top view of the juice extraction device bottom cover that is shown in FIG. 25;

FIG. 27 is the top view of the filter net that is shown in FIG. 2;

FIG. 28 is the perspective view of the pedal blade that is shown in FIG. 2;

FIG. 29 is the perspective view of the meat grinding screw bolt that is shown in FIG. 2;

FIG. 30 is the perspective view of the meat grinding screen board that is shown in FIG. 2;

### DETAILED DESCRIPTION

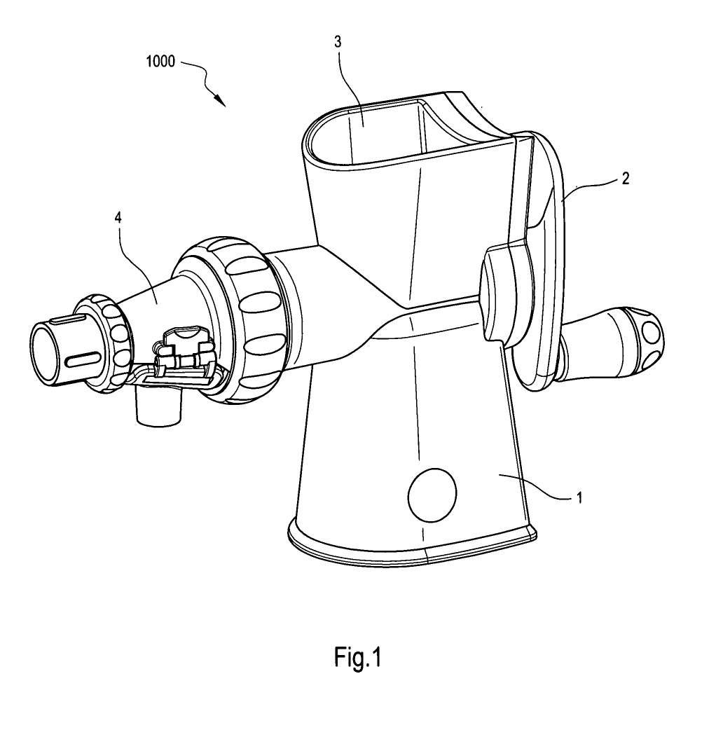

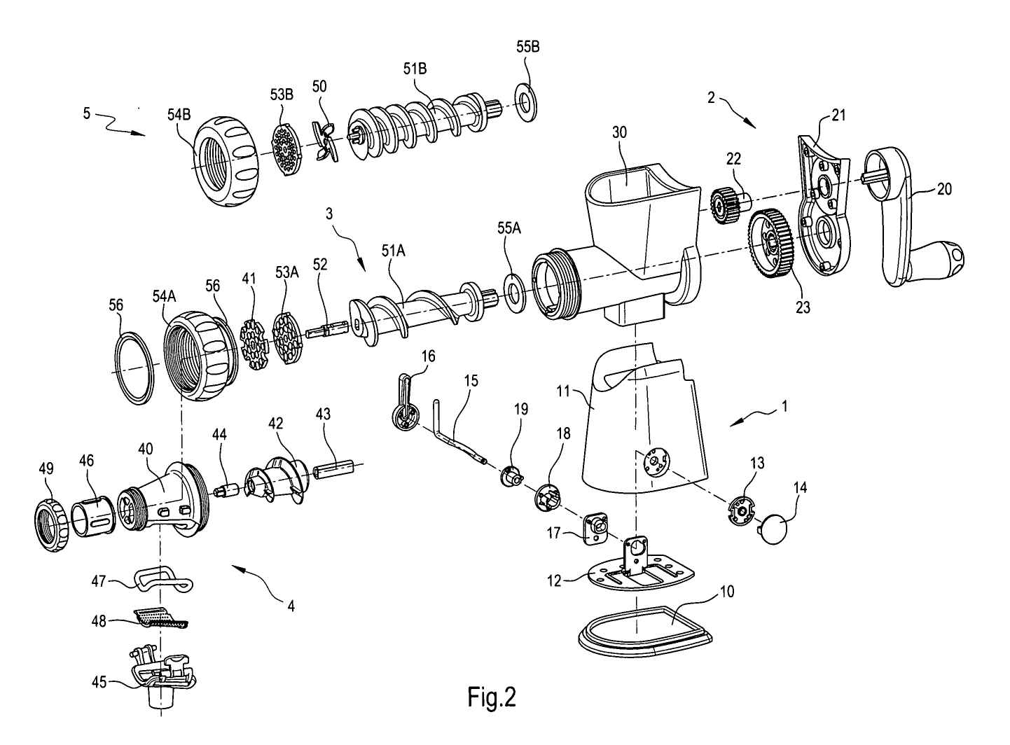

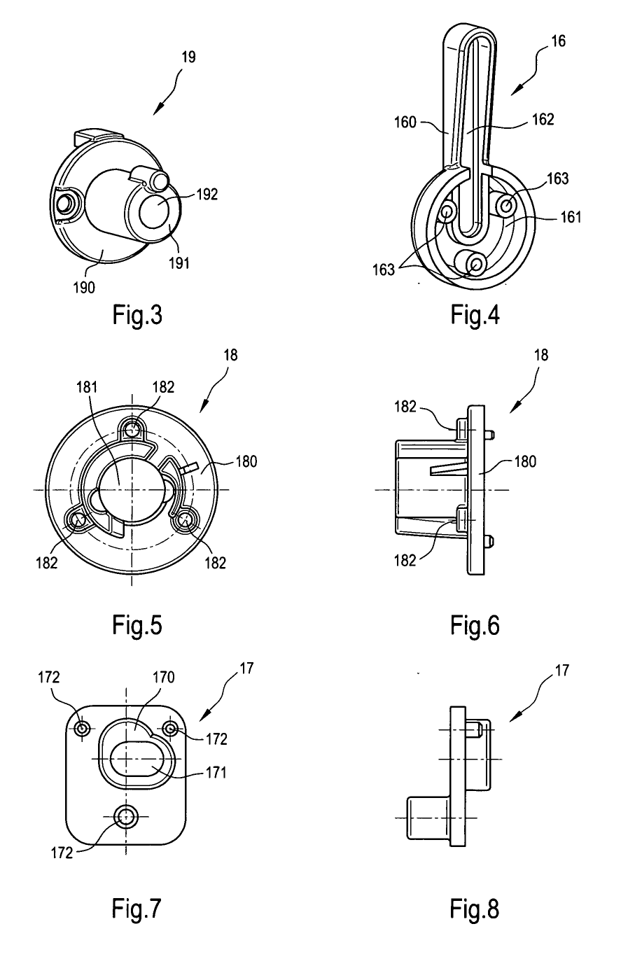

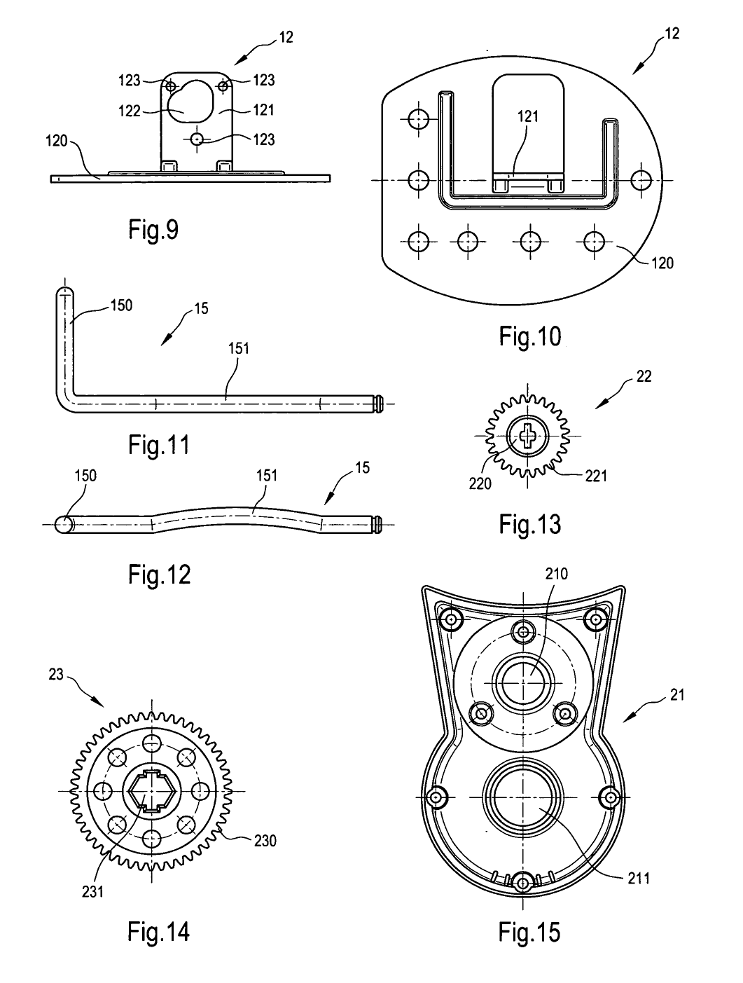

Please refer to FIG. 1 and FIG. 2 first. FIG. 1 is the perspective view of this multi-function juicer invention 1000. FIG. 2 is the dissembled view of this multi-function juicer invention 1000. It includes: a vacuum mounting device 1 that is at the bottom of the multi-function juicer invention 1000; a mechanical device 2 that is on one side of the upper part of this multi-function juicer invention 1000; a juicer body 3 that is on top of the vacuum mounting device 1; a aux juice extraction device 4 that is connected to the juicer body 3; and a meat grinding unit 5 that can replace some components inside the juice extraction device 1 to serve the meat grinding purpose. The vacuum mounting device 1 includes: a vacuum disk 10 that is at the bottom of the vacuum mounting device 1, whose shape is completely covered by the base unit 11, which is made of flexible materials; a base unit 11 that covers the vacuum disk 10, whose bottom shape matches to the shape of the vacuum disk 10—its center is empty so that the other components of the vacuum mounting device 1 can operate inside; besides, on both sides of it there is a hole to hold vacuum disk controller 15 inside them, and the saddle shaped top of base unit 11 can match the bottom of the device body 30; a vacuum disk shelf 12 that is placed on top of the vacuum disk 10, whose vacuum disk shelf base 120's (FIG. 9 and FIG. 10) shape is similar to the shape of the inner side of vacuum disk 10 so that the two can stick together; at the same time, there is a vacuum disk shelf stand 121 at the center of vacuum disk shelf base 120 (as shown in FIG. 9 and FIG. 10). A bean shaped vacuum disk controller holding hole 122 locates at the center of vacuum disk shelf stand 121, which allows the vacuum disk controller 15 to go through to control the up and down of the vacuum disk shelf 12. To the outside of the vacuum disk controller holding hole 122 there are three vacuum disk shelf connection hole 123 (as shown in FIG. 9 and FIG. 10) to connect the shelf to vacuum disk shelf connector 17. A vacuum disk controller 15 is placed inside the base unit 11, whose L shape can be divided into two parts: the short part is the controller-handler connection 150, which connects the controller with vacuum disk control handler 16. The longer part is the controller stick 151, which passes through the vacuum disk controller holding hole 122 to control the up and down of the vacuum disk shelf 12. The center portion is slightly extended out. When the vacuum disk controller 15 is rotated, the vacuum disk shelf 12 will be raised. A controller locking unit 13 is placed in one side of the base 11 to lock the vacuum disk controller 15. In the center of it there is a hole that is the axle basis when vacuum disk controller 15 rotates. A controller cover 14 is used to cover one side of base 11. It is placed right on top of the controller locking unit 13. A vacuum disk control handle 16 is placed on the other side of the base 11 to control the movement of vacuum disk 10. It consists of two parts: handle 160 (as shown in FIG. 4) and handle body 161 (as shown in FIG. 4). In the center of handle 160 is the handle-controller holding hole 162 (as shown in FIG. 4). There are three handle connection hole 163 in the inner surface of handle body 161 (as shown in FIG. 4) to connect to controller sealer 18. A vacuum disk shelf connector 17 is installed right next to vacuum disk shelf stand 121. In the center of vacuum disk shelf connector 17 there is a bean shaped connector block 170 (as shown in FIG. 7 and FIG. 8), which matches the vacuum disk controller holding hole 122. In the center of connector block 170 there is a block controller holding hole 171 (as shown in FIG. 7 and FIG. 8), which allows vacuum disk controller 15 to pass through. On the outer rim there are three connector connection hole 172 (as shown in FIG. 7 and FIG. 8) that can be used to connect controller sealer 18 and vacuum disk 12. A controller locking unit 19 is right next to the inner surface of vacuum disk control handler 16. It is placed right between vacuum disk control handler 16 and controller sealer 18. A controller locking unit pole 191 (as shown in FIG. 3) rises in the center of the controller locking unit body 190 (as shown in FIG. 3). Pole 191 is a large column with a small column attached to it. In its center is the locking unit controller passing hole 192 (as shown in FIG. 3). A controller sealer 18 is placed inside base 11, which will support controller locking unit 19 together with vacuum disk handler 16. In the center of the controller sealer body 180 (as shown in FIG. 5 and FIG. 6), there is a sealer controller passing hole 181 (as shown in FIG. 5 and FIG. 6). Its shape is identical to the controller locking unit pole 191. There are three sealer connection hole 182 on the outside (as shown in FIG. 5 and FIG. 6), which are used to lock in controller sealer 18 and vacuum disk handler 16.

The mechanical unit 2 includes a gearbox that is in the center of the mechanical device. On the center of its surface there are a small gear holding pole 210 (as shown in FIG. 15) and large gear holding pole 211 (as shown in FIG. 15). A rotating handler 21 is outside gearbox 21. There are also a small gear 22 and a large gear 23, which is placed on the small gear holding pole 210 and large gear holding pole 211. The center axle of small gear 220 (as shown in FIG. 13) is very long so that it can be connected to the rotating handler 20. The gear teeth 221 (as shown in FIG. 13) bite into the teeth of large gear 230 (as shown in FIG. 14) to drive the motion. In the center of large gear 23 there is a gear shaped hole large gear center hole 231 (as shown in FIG. 14).

The body unit 3 includes: a body unit 30 that is placed on top of base 11, whose bottom's shape matches the saddle shaped top of base 11; and, a pedal blade 50 that can replace juice extraction screen board 41 to grind meat.

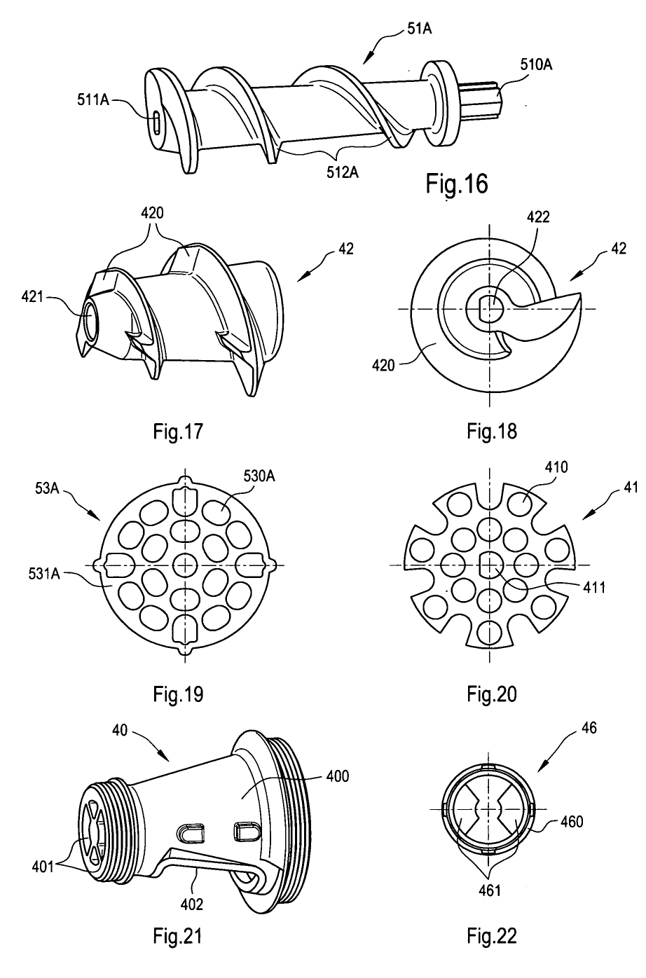

The juice extraction device 4 includes: a horizontal cone shaped juice extraction body unit 40 in the center of juice extraction device 4. To the right of the device body 40 (the bottom of the cone) is the inlet of body unit 400 (as shown in FIG. 21). To the left (the tip of the cone) are two pulp outlets 401 (as shown in FIG. 21). At the bottom of the body unit 40 there is a juice outlet 402 (as shown in FIG. 21). A main screw bolt 51A is placed inside the body unit 30, with a small bolt gear 510A at the tail (as shown in FIG. 16), which can be placed completely into big gear center hold 231. On the head of the main screw bolt 51A is a screw thread 512A (as shown in FIG. 16). It comes with a main screw bolt hole 511A on the front end (as shown in FIG. 16). A main screw bolt skirt 55A is placed at the end of the main screw bolt 51A to seal the space between main screw bolt 51A and big gear 23, which ensures a smooth rotation. A small axle of main screw bolt 52 is placed inside main screw bolt hole 511A. It consists of two parts. The larger part is placed in the main screw bolt hole 511A. The smaller part extends outside main screw bolt 51A. A main screen board 53A is installed on the outlet of the body unit 30. The rims of every hole 530A (as shown in FIG. 19) on it are sharp blades. The shape of the body 531A (as shown in FIG. 19) matches the shape of the outlet of body unit 30. A body nut 54A is attached to the outlet of body unit 30, and two water proof sealing rings 56 are placed adjacent to it. An aux screw bolt 42 is placed in the juice extraction device body 40. It is a cone shape with screw thread 420 (as shown in FIG. 17 and FIG. 18) on it. At the head there is a aux screw bolt axle hole 421 (as shown in FIG. 17 and FIG. 18), and the rear end there is a aux screw bolt tail axle hole 422 (as shown in FIG. 17 and FIG. 18). An aux screw bolt small axle 44 is placed in the aux screw bolt axle hole 421. It consists of two parts. The larger one hides inside the aux screw bolt axle hole 421. The smaller one extends outside aux screw bolt 42. An aux screw bolt tail axle 43 is placed inside the aux screw bolt tail axle hole 422. It is hollow, which will allow the extended portion of main screw bolt small axle 32 to be inserted into it. Thus the main screw bolt 51A can drive the aux screw bolt 42 to rotate. A juice extraction screen board 41 is placed outside main screen board 53A. The edges of every hole 410 on it (as shown in FIG. 20) are sharp blades. A device bottom cover 45 is installed beneath the device unit 40. Its body 450 (as shown in FIG. 25 and FIG. 26) is a twisted platform, which matches the shape of the outlet 402 of the juice extraction device body. At the center of the bottom cover 45 is a round bottom cover outlet 451 (as shown in FIG. 25 and FIG. 26). Right beneath this bottom cover outlet 451 there is a juice outlet pipe 452 (as shown in FIG. 25 and FIG. 26) extending from the bottom cover downward. A bottom cover sealer 47 surrounds this juice extraction bottom cover 45. Its shape is such that it covers the full edge of this juice extraction bottom cover 45 to avoid the leakage of juice between the juice extraction unit body 40 and the juice extraction device bottom cover 45. A filter net 48 is placed at the center of the juice extraction bottom cover 45. Its body 480's shape (as shown in FIG. 27) matches the center of the juice extraction bottom cover 45, which allows the filter net 480 to cover the bottom cover outlet 451. Inside the filter net 480 are many juice filtering holes 481 (as shown in FIG. 27). A wetness control unit 46 is connected to the pulp outlet 401 of the juice extraction device. The body 460 (as shown in FIG. 22) is a cylinder. There are two pulp outlets 461 (as shown in FIG. 22) on both sides of the side that is facing juice extraction device body 40. A juice extraction device nut 49 attaches to the outlet of the extraction device unit 40, which connects the wetness control unit 46 to the extraction device body 40.

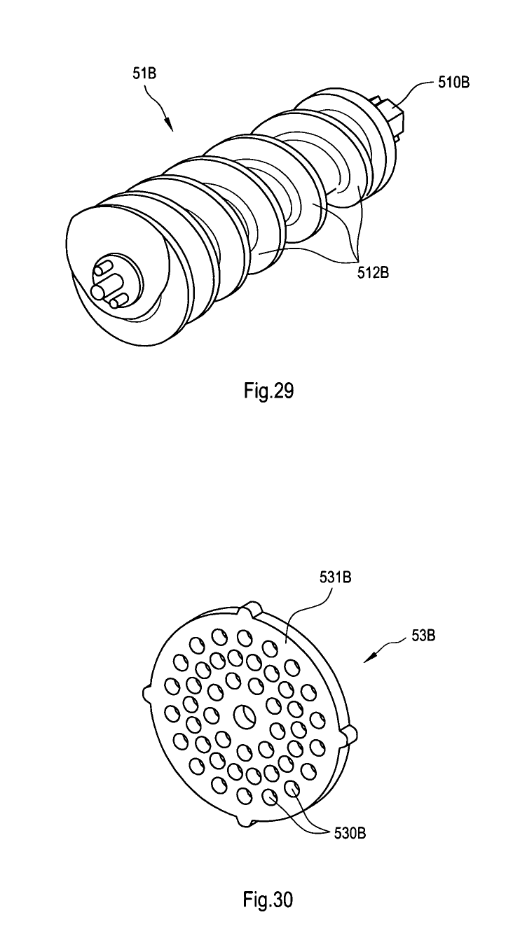

Finally, the meat grinding unit 5 includes: a meat grinding screw bolt 51B that can replace the main screw bolt 51A. It has a small screw bolt gear 510B (as shown in FIG. 29) in the tail. The whole small screw bolt gear 510B can be placed in the large gear center hole 231 (as shown in FIG. 29). The head of the meat grinding screw bolt 51B is a cylinder with screw thread 512B (as shown in FIG. 29). A meat grinding screw bolt skirt 55B is placed at the end of the meat grinding screw bolt 51B. It seals the space between the tail of meat grinding screw bolt 51B and the large gear 23, and makes the rotation smoother. A meat grinding screen board 53B can replace the main screen board 53A. All edges of the holes 530B (as shown in FIG. 30) are sharp blades. Its shape 531B (as shown in FIG. 30) matches the outlet of device body 30. A body meat grinding nut 54B can replace the body nut 54A. And there is a pedal blade 50 that can replace the juice extraction screen board 41 to serve the meat grinding purpose.

Next, please refer to FIG. 3 to FIG. 12. These Figures illustrate the different components of this invention's vacuum mounting device 1 from different angles. It includes: FIG. 3, the perspective view of the controller locking unit 19; FIG. 4, the perspective view of the vacuum disk control handler 16; FIG. 5 and FIG. 6, the front view and the side view of the controller sealer 18; FIG. 7 and FIG. 8, the front view and the side view of the vacuum disk shelf connector 17; FIG. 9 and FIG. 10, the side view and the top view of the vacuum disk shelf 12; and FIG. 11 and FIG. 12, the top view and the front view of the vacuum disk controller 15. These Figures are a good supplement of the abovementioned installation process. They can also help to illustrate the operation of vacuum mounting device 1. Before the operation of this juicer 1000, pull down the handler 160, the vacuum disk controller 15 that is inside the handle controller holding hole 162 will be pulled down, too. Thus the handle controller connector 150 will move from the vertical status to horizontal status. The controller stick 151 will rotate in the connector controller holding hole 171. Then the bulging portion in the center will point vertically instead of horizontally. Since the connector control holding hole 171 is a ellipse, the vacuum disk shelf connector 17 will be raised, thus pulling vacuum disk shelf 12 and base vacuum disk 10 up. At the same time, the rim of vacuum disk 10 stays on the kitchen table, thus creates a vacuum place between the kitchen table and vacuum disk 10. This multi-function juicer will then be mounted to the table.

Next please refer to FIG. 13 to FIG. 15. They show the different components of the mechanical unit 2 of this invention from different angles. They include: FIG. 13, the bottom view of the small gear 22; FIG. 14, the bottom view of the large gear 23; and FIG. 15, the top view of the gearbox 21. These Figures are a good supplement of the abovementioned installation process. They can also help to illustrate the operation of mechanical unit 2. During the operation of this juicer 1000, the user manually rotates the rotating handle 20, which drives the small gear 22 to rotate by pulling the small gear axle 220 that is connected to the rotating handler 20. Since the teeth of small gear 221 bite into the teeth 230 of large gear, the large gear 23 is driven to rotate, too.

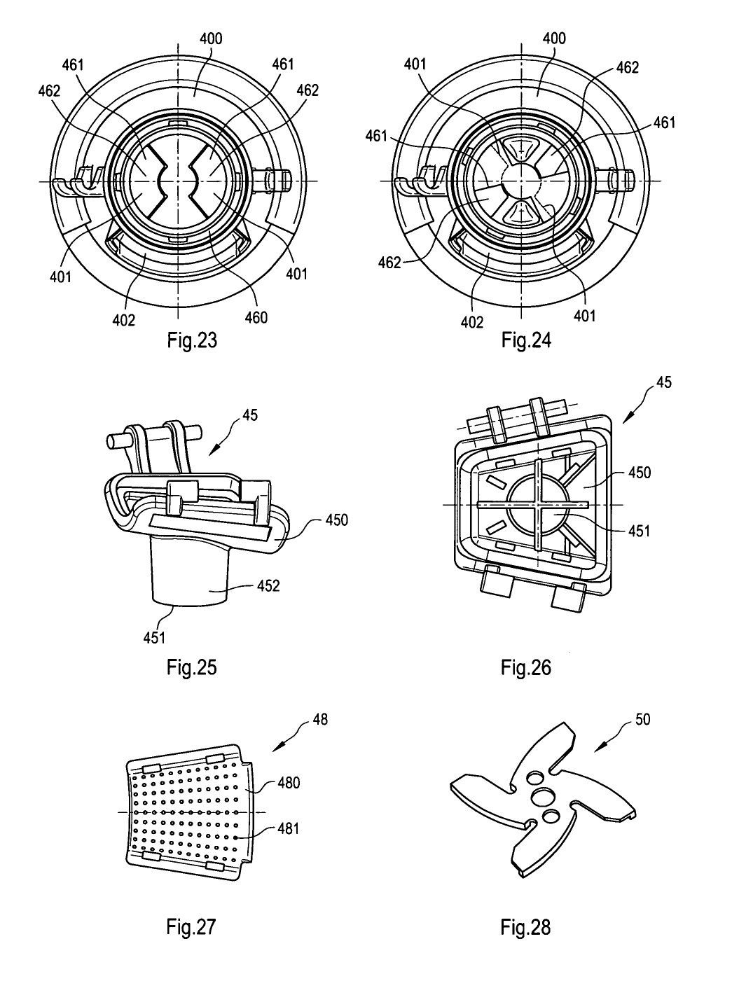

Please then refer to FIG. 16 to FIG. 27. They show the different components of the juice extraction device 4 of this invention from different angles. They include: FIG. 16, the perspective view of the main screw bolt 51A; FIG. 17 and FIG. 18, the perspective view and the side view of the aux screw bolt 42; FIG. 19, the bottom view of the main screen board 53A; FIG. 20, the bottom view of the juice extraction screen board 41; FIG. 21, the perspective view of the juice extraction body 40; FIG. 22, the side view of the wetness control unit 46; FIG. 23 and FIG. 24, the combined front view of the juice extraction body that is shown in FIG. 21 and the wetness control unit that is shown in FIG. 22 after they are installed together and placed in status 1 and status 2; FIG. 25 and FIG. 26, the perspective view and the top view of the body 450 of the juice extraction device bottom cover 45; and FIG. 27, the top view of the filter net. These Figures are a good supplement of the abovementioned installation process. They can also help to illustrate the operation of the juice extraction device 4. As explained above, when the large gear 23 rotates, since the screw bolt gear 510A is placed into the large gear center hole 231, the motion is passed to the main screw bolt 51A, thus drive the main screw bolt 51A to rotate. The screw thread 512A will generate a forward motion when rotating together with the main screw bolt 51A. Thus the food inside the device body 30 will be pushed forward towards the outlet. When the food is pushed through the holes 530A of main screen board 53A, it is smashed by the sharp blades and thus reduced the volume. Besides, since the main screw bolt small axle 32 passes through both the central hole 411 of the juice extraction screen board 41 and the aux screw bolt tail axle 43, and the central hole 411 and the aux screw bolt tail axle 43 has the same profile shapes, the juice extraction screen board 41 and aux screw bolt 42 are also be driven to rotate. Food will be further smashed by the sharp edges of the holes 410 on the juice extraction screen board 41. Then it will enter the juice extraction device body 40 for further processing. When the pretreated food enters the juice extraction device body 40 through the juice extraction device body 40 entrance 400, the screw thread 420 on the aux screw bolt 42 will rotate together with the main screw bolt 51A. This, too, will generate a forward motion. Thus the food in the juice extraction device body 40 gets pressed in a small space. The cone shape of juice extraction device body 40 will also make the pressure on the food inside larger and larger, thus separates juice from pulp. Pulp will be pushed out from the juice extraction device body 40 through the juice extraction device pulp outlet 401 by the forward moving aux screw bolt screw thread 420. While juice drips down to leave the juice extraction device body 40 through the juice extraction device juice outlet 402 by gravity. After the pulp leaves the juice extraction device body 40, they will go through the wetness control unit pulp outlet 461 of the wetness control unit 46, to be discharged from the multi-function juicer 1000. As shown in FIG. 23, when the juice extraction device body 40 and the wetness control unit are connected in status 1, the juice extraction device pulp outlet 401 is completely overlapped with the wetness control unit pulp outlet 461. The actual pulp outlet 462 is of the same size as the two outlets. A larger actual pulp outlet 462 makes the pulp to be released faster, shortens the time that food stays in the juice extraction device body 40 and device body 30. That makes the separation of pulp and juice less complete. Thus the pulp is wetter, and less juice is produced. On the other hand, as shown in FIG. 24, when the juice extraction device body 40 and the wetness control unit are connected in status 2, the juice extraction device pulp outlet 401 is not completely overlapped with the wetness control unit pulp outlet 461. The actual pulp outlet 462 is of a smaller size than the two outlets. A smaller actual pulp outlet 462 makes the pulp to be released slower, increases the time that food stays in the juice extraction device body 40 and device body 30. That makes the separation of pulp and juice more complete. Thus the pulp is dryer, and more juice is produced. From the illustration above we can see that, if the user wants to produce juice from juicier fruits, he must adjust the wetness control unit 46 to status 1, to make the pulp to discharge easily, and get juice. On the contrary, if the user wants to get juice from less juicier fruits, he needs to adjust the wetness control unit 46 to status 2, thus increases the time that food stays in the juice extraction device body 40 and device body 30. That will help to produce more juice from the fruit. When the juice trickles down the juice extraction device juice outlet 402 to leave the juice extraction device body 40, it will pass the juice filter 481 on the filter net 480 to remove the small pulps and particles. It will then be discharged out of the multi-function juicer 1000 through the bottom cover outlet 451 via the juice outlet pipe 452.

Finally, FIG. 28 to FIG. 30 show the different components of the meat grinding device 5 of this invention from different angles. They include: FIG. 28, the perspective view of the pedal blade 50; FIG. 29, the perspective view of the meat grinding screw bolt 51B; and FIG. 30, the bottom view of the meat grinding screen board 53B. These components can switch the function of the multi-function juicer 1000 from juice extraction to meat grinding. First, remove the whole juice extraction device 4. Then, place the whole meat grinding device 5 into the device body 30. Replace the main screw bolt 51A with meat grinding screw bolt 51B. Replace the main screen board 53A with meat grinding screen board 53B. Then place pedal blade 50 between the meat grinding screw bolt 51B and the meat grinding screen board 53B. Then replace body nut 54A with meat grinding body nut 54B. Then the juice extraction device 1000 will be converted into a meat grinder, which is very convenient.

From the abovementioned structure we can see that, based on the creative design of the invention, the multi-function juicer is very easy to operate. First, rotate vacuum disk control handler 16 to mount the juicer 1000 on the kitchen table. Then, repetitively rotate rotating handler 20 to drive the screw bolt 51A and 42 and pedal blade 50 or juice extraction screen board 41 to rotate. Thus the meat or fruit in the device body unit 30 will be smashed into small pieces by the pedal blade 50 or juice extraction screen board 41 to be further processed into ground meat or fruit juice. In addition to changing the configuration to serve different purposes, multi-function juicer 1000 can adjust the wetness control unit 46 to control the retention time of food in the juice extraction device body 40 and device body 30. Thus it creates a higher performance for juice production for different fruits. It does not need an extra process to separate juice from pulp, or to adjust the wetness of the pulp, which is very convenient.

What is claimed is:

1. A multi-function juicer, which includes the following components:
A vacuum mounting base unit on the bottom of the multi-function juicer. This vacuum base includes:
A vacuum disk that is on the bottom of the mounting vacuum base unit;
A base that covers the abovementioned vacuum disk;
A vacuum disk shelf on top of the vacuum disk;
A vacuum disk controller inside the base;
A controller fixing unit that is on the side of the base to lock the vacuum base controller;
A controller cover that is used to cover one side of the base;
A vacuum disk control handler on the other side of the base to control the operation of the vacuum disk;
A vacuum disk shelf connector that is next to vacuum disk shelf stand;
A controller locking unit that is right next to the inner side of the abovementioned vacuum control handler; and
A controller sealer that is inside the base, which, together with the vacuum base control handler, will hold the controller locking unit.
A mechanical device on one side of the upper part of multi-function juicer. This mechanical device includes:
A gearbox at the center of the mechanical device;
A rotating handler that is placed outside the gearbox; and
A big gear and a small gear inside the gearbox.
A juicer body that is placed on top of the vacuum mounting base. This body includes:
A body part that is on the top of the base.
A juice extraction device that is connected to the juicer body. This juice extraction device includes:
A juice extraction device body that is at the center of the juice extraction device;
A main screw bolt inside the device body;
A main screw bolt skirt that is placed at the end of the main screw bolt;
A small axle of the main screw bolt that is inside the main screw bolt;
A main screen board that is at the outlet of the device body;
A body nut that is attached to the abovementioned outlet of the device body;
Two sealing rings that are closely attached to the body nut;
An aux screw bolt that is inside the device body;
A small bolt of the aux screw bolt that is placed inside the aux screw bolt;
An aux screw bolt tail axle that is placed in the tail of the aux screw bolt;
A juice extraction screen board that is right on the outside of the main screen board;
A juice extraction device bottom cover that is placed on the bottom of the juice extraction device body;
A bottom cover sealer that surrounds that rim of the juice extraction device bottom cover;
A filter net that is placed on the center of the juice extraction device bottom cover;
A wetness control unit that is connected to the outlet of the device body; and
A juice extraction device nut that is tightened to the outlet of the device body.
A meat grinding unit that can be exchanged with some of the components in the juice extraction device to serve meat grinding purpose. This meat grinding unit includes:
A meat grinding screw bolt that can replace the main screw bolt to grind meat;
A meat grinding screw bolt skirt that is placed at the tail of the meat grinding screw bolt;
A meat grinding screen board that can replace the main screen board to grind meat;
A meat grinding body nut that can replace the body nut to grind meat; and
A pedal blade that can replace the juice extraction screen board to grind meat.

2. The multi-function juicer of claim 1 further comprising there is a bulging part in the center of said longer portion of the controller stick of the vacuum disk controller, wherein when the controller is set vertically, the center of it extends horizontally and when the controller is placed horizontally, the center of it extends vertically.

3. The multi-function juicer of claim 2 wherein the center of the abovementioned vacuum disk controller is placed right in the connector controller holding hole.

4. The multi-function juicer of claim 1 wherein said vacuum disk shelf base has the same shape as the vacuum disk.

5. The multi-function juicer of claim 1 wherein there is a standing vacuum disk shelf stand in the center of the vacuum disk shelf, in the center of the vacuum disk shelf stand is a vacuum disk shelf controller holding hole, said hole connecting to the vacuum disk shelf connector, wherein the center of the vacuum disk controller can be installed inside the connector controller holding hole and the controller can rotate.

6. The multi-function juicer of claim 1 with this feature: The vacuum disk is flexible. It will change its shape under external force.

7. The multi-function juicer of claim 1 wherein said main screw bolt small axle consists of two potions, a larger portion which fits into the main screw bolt axle hole, and a smaller portion extending outside the main screw bolt.

8. The multi-function juicer of claim 7 wherein the profile section of the smaller portion of the main screw bolt small axle matches the shape of the juice extraction screen board and aux screw bolt tail axle's profile and drives the juice extraction screen board and aux screw bolt to rotate together.

9. The multi-function juicer of claim 1 wherein the two small axles on top of said meat grinding screw bolt match the corresponding holes on the pedal blade and drive the pedal blade to rotate.

10. The multi-function juicer of claim 1 wherein there is a screw thread on the surface of the main screw bolt, which screw thread rotates together with the main screw bolt and forms a forward motion whereby the food in the device body will be pushed forward towards the outlet.

11. The multi-function juice of claim 1 wherein there is a screw thread on the surface of the aux screw bolt, which screw thread rotates together with the aux screw bolt, and forms a forward motion whereby the food in the device body will be pushed forward towards the outlet.

12. The multi-function juicer of claim 1 wherein there is a screw thread on the surface of the meat grinding screw bolt, which screw thread rotates together with the meat grinding screw bolt, and forms a forward motion whereby the food in the device body will be pushed forward towards the outlet.

13. The multi-function juicer of claim 1 wherein said main screen board is the same shape as the meat grinding screen board and the holes are smaller than the holes on the main screen board, and the holes on the meat grinding screen board are present at a higher density than the holes on the main screen board.

14. The multi-function juicer of claim 1 wherein said juice extraction device body has a large entrance and gradually becomes smaller until the outlet end of the body distal from the entrance and there are two juice extraction pulp outlets, one on each side of the outlet end and at the bottom of the device body there is a juice extraction device juice outlet.

15. The multi-function juicer of claim 1 wherein there are two wetness control pulp outlets, one on either side of device body facing surface of the wetness control unit.

16. The multi-function juicer of claim 12 wherein after the wetness control unit is installed with the juice extraction device body, the wetness control pulp outlet is parallel with the juice extraction juice outlet.

17. The multi-function juicer of claim 12 wherein the rotation of the wetness control unit will change the amount of overlap of the wetness control pulp outlet and juice extraction device juice outlet, and thereby control the size of the pulp outlet, and thus control the discharge rate of the pulp.
